(19) United States
(12) Patent Application Publication
(10) Pub. No.: US 2026/0202584 A1
(43) Pub. Date: Jul. 16, 2026

(54) IR REFLECTING WINDOW FILM USING METALLIC NANO MASKS FOR SELECTIVE WAVELENGTH REFLECTION

(71) Applicant: Lumenco Scientific, LLC, Englewood, CO (US)

(72) Inventors: Mark A. Raymond, Littleton, CO (US); Hecto Andres Porras Soto, Littleton, CO (US); Tyler Kapus, Aurora, CO (US)

(21) Appl. No.: 19/058,791

(22) Filed: Feb. 20, 2025

Related U.S. Application Data
(60) Provisional application No. 63/744,629, filed on Jan. 13, 2025.

(51) Int. Cl. G02B 1/11

(52) U.S. Cl. CPC G02B 1/11

(57) ABSTRACT

An infrared (IR) reflecting film system. The film system includes a substrate having a first surface capable of being adhered to a transparent sheet of material and a microstructure surface of the substrate opposite the first surface of the substrate. The film system also includes a plurality of microstructures cooperating to form the microstructure surface of the substrate, each microstructure with a recessed surface. The film system also includes a metallic layer disposed on the microstructure surface to reflect IR and a plurality demetaliztion areas disposed in the metallic layer sized to permit the transmission of visible light and limit the transmission of light wavelengths that correspond to IR. A method of fabricating the IR window film system. The method includes the step of forming a plurality of microstructures on a substrate to create a microstructure surface on the substrate, each of the microstructures having a recessed surface. The method also includes the step of depositing a metallic layer on the microstructure surface of the substrate that reflects a light wavelength greater than about 950 nanometers (nm).

### CROSS-REFERENCE TO RELATED APPLICATIONS

The present application is a conversion of U.S. Provisional Application having U.S. Ser. No. 63/744,629, filed Jan. 13, 2025, which claims the benefit under 35 U.S.C. 119(e). The disclosure of which is hereby expressly incorporated herein by reference.

### STATEMENT REGARDING FEDERALLY SPONSORED RESEARCH OR DEVELOPMENT

Not applicable.

### BACKGROUND OF THE DISCLOSURE

### 1. Field of the Invention

The present disclosure relates to an IR reflecting film that includes a plurality of structures, each with a recessed surface, formed on a top surface of a substrate. The IR reflecting film includes a reflective mask on the top or bottom surfaces (or both) of the substrate that includes reflective elements each disposed in the structure's recessed surfaces. In use, the IR reflecting film reflects sunlight having a wavelength greater than about 850 nanometers (nm) and allows most of the visible light to be transmitted through the film.

### 2. Description of the Related Art

IR absorbing and reflecting films have been around for some time. The normal challenges with the films are that visible light and the clarity of the window film is often limited due to the technology used to absorb or reflect the unwanted infrared. Some films use a combination of coatings with different refractive indices to absorb IR, while others use vapor deposition or sputtering. Both technologies have drawbacks; first, IR absorbing films can absorb heat and have been known to shatter glass after absorbing too much heat; second, sputtered or vapor deposition films can oxidize and block too much visible light.

Accordingly, there is a need for a technology that encapsulates metallic components and allows visible light through the film while selectively reflecting (not absorbing) IR.

### SUMMARY OF THE DISCLOSURE

The present disclosure is directed to an infrared (IR) reflecting film system. The film system includes a substrate having a first surface capable of being adhered to a transparent sheet of material and a microstructure surface of the substrate opposite the first surface of the substrate. The film system also includes a plurality of microstructures cooperating to form the microstructure surface of the substrate, each microstructure with a recessed surface. The film system also includes a metallic layer disposed on the microstructure surface to reflect IR and a plurality demetaliztion areas disposed in the metallic layer sized to permit the transmission of visible light and limit the transmission of light wavelengths that correspond to IR.

The present disclosure also directed to a method of fabricating an IR window film system. The method includes the step of forming a plurality of microstructures on a substrate to create a microstructure surface on the substrate, each of the microstructures having a recessed surface. The method also includes the step of depositing a metallic layer on the microstructure surface of the substrate that reflects a light wavelength greater than about 950 nanometers (nm).

### BRIEF DESCRIPTION OF THE DRAWINGS

FIG. 1 is a cross-sectional view of an IR film system disposed on a transparent sheet of material constructed in accordance with the present disclosure.

FIG. 2 illustrates a side or end view of a film or device layer that can be formed by de-metallization to have linear, V-shaped grooves or recessed portions (or “microstructures”).

FIG. 3 is a top view of a film or device layer that can be formed by de-metallization to have hexagonal shaped grooves or recessed portions (or “microstructures”).

FIG. 4 is a microscope view of another film or device layer similar to FIG. 1 but with linear grooves or microstructures of differing widths.

FIG. 5 illustrates the film or device layer of FIG. 1 after metallization has been performed to provide a top or covering metallic layer.

FIG. 6 illustrates the film or device layer of FIG. 5 after application of a resist coating and removal of the metal upper or coating layer except where covered by the resist coating.

FIG. 7 illustrates the film or device layer of FIG. 6 after removal of the resist coating and during use to reflect higher wavelength (or heat generating) light such as that of the IR wavelength or longer.

### DETAILED DESCRIPTION OF THE DISCLOSURE

The present invention is directed to an approach of using a nano mask technology incorporated into a film having a layer of metal that will reflect all or most of the infrared radiation (IR) and let nearly all visible light through the film. Visible light can pass through the film by creating “holes” or clear areas in the layer of metal that are smaller than the wavelength of the IR. More specifically, the film detailed herein can achieve IR reflectance and solar heat rejection without absorption of near infrared heat energy while having superior visible light transmission without expensive metallic components. The balance between reflectance and absorption is struck within a narrow band of the near infrared (NIR) solar energy interval. Solar heat is derived principally from the near infrared energy interval, with about 71% of the weighted spectral power distribution occurring within a narrow band of from about 900 to about 1400 nanometers (nm). It is within this narrow band that the balance is struck.

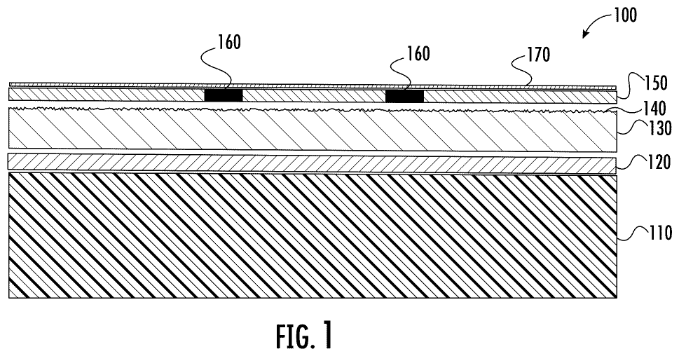

Referring now to FIG. 1, shown therein is an IR reflecting film system 100 that can be secured on a transparent material 110, such as a window or a see-through door, via an adhesive layer 120. The IR reflecting film system 100 includes a microstructure surface 130 (or film or layer) created on a substrate 140 and a metallic layer 150 disposed on the microstructure surface 130 of the substrate 140. The metallic layer 150 can include demetallization areas 160 that are sized to permit visual light to pass through and permit the metallic layer 150 to reflect a substantial amount of the IR. The IR reflecting film system 100 can also include a hardcoat 170 disposed over the metallic layer 150 and the exposed microstructure surface 130 to protect the metallic layer 150 and the exposed microstructure surface 140. The IR reflecting film system 100 can be installed on the inside or outside of a transparent material 110 depending upon the desired application thereof.

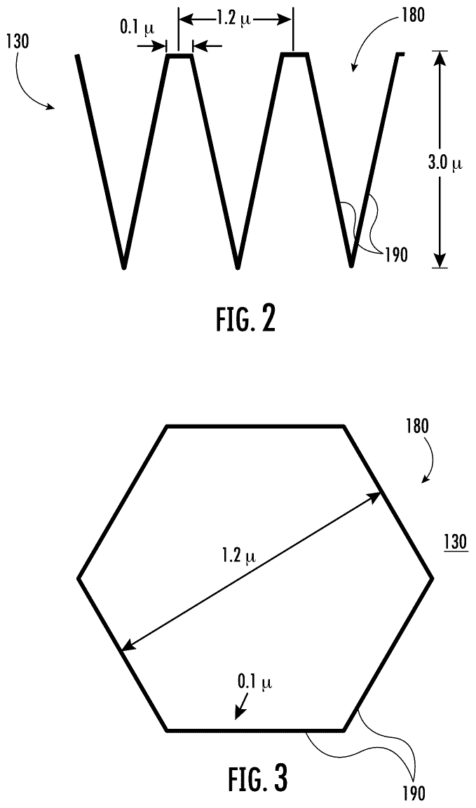

The microstructure surface 130 can be created in the substrate 140 via any manner known in the art. Examples of techniques that can be used to create the microstructure surface 130 include silicon wafer and electron beam imaging or an etching process. The microstructures can be any shape desirable such that the desired IR reflection is achieved. Examples of microstructure shapes includes, but is not limited to, linear grooves, round, hexagonal or square. For example, FIG. 2 illustrates, with a linear side or end view, the microstructure surface (or layer of a device) 130 with a plurality of side-by-side linear grooves 180 defined by opposing sidewalls 190 to provide a V-shaped cross-sectional shape in this non-limiting example. Exemplary dimensions are provided for the width and height of the groove 180 was well as for the spacing between adjacent grooves 180 in the film, wafer, or microstructure surface 130 (groove 180 may be formed in a top or outer surface of the body or substrate 140). Such a fabrication process is necessary or better than using a traditional laser system due to the feature size and necessary specifications for the tooling, which involves sub-micron features with three-dimensional (3D) etching and aspect ratios that are generally deeper than their X or Y axis. The fabrication or manufacturing methods for resist or tooling may include one or more of the following: (1) the use of E-beam imaging for making the wafer material or tooling or laser imaging using a photo resist process; (2) direct laser ablation; (3) gray scale lithography; (4) micro etching or diamond turning; and (5) micro scale 3d printing.

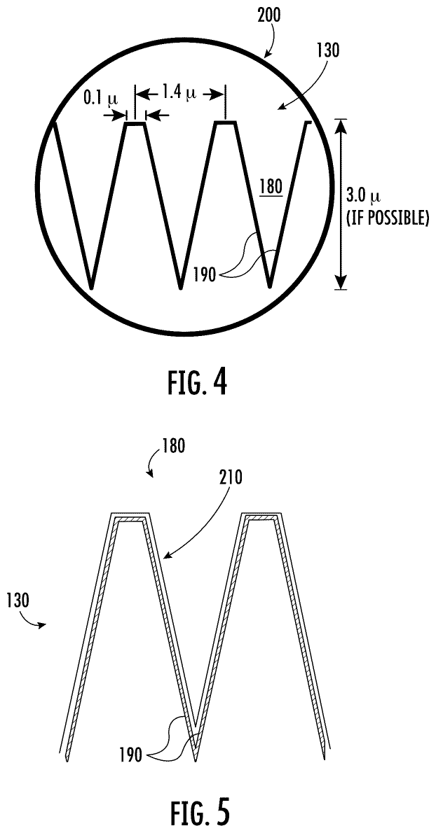

An overhead or top view of the microstructure surface 130 (or the grooves or recessed portions 180) of a hexagonal shape defined by sidewalls 190, with one being shown for simplicity of illustration with the understanding that many more would typically be formed on the microstructure surface 130. Dimensions for the groove 180 are shown in FIG. 3 including the center-to-center distance of 1.2 micrometers and the length of the sidewalls 190 of 0.1 micron. The other aspect ratios of depth need for the wafer (or film or layer) are generally 2 to 1 (depth to X or Y axis) and preferably 3 to 1. An overhead view 200 from an SEM microscope of microstructure surface 130 similar to that shown in FIG. 2 is provided in FIG. 4, with the microstructure surface 130 shown to include a plurality of the linear grooves or microstructures 180 defined by sidewalls 190. The grooves 190 have similar height and spacing to those shown in FIG. 2 but with a differing width (e.g., 1.4 microns rather than 1.2 microns).

Generally, the next step in the process is to electroform the tool into a master nickel tool that can be copied or replicated hundreds of times. This tool is generally used to create a larger tool via a step and repeat process using UV polymers or heat and pressure, replicating the original tool as perfectly as possible to make a large production shim or tool that can be mounted on a cylinder for production. In a preferred method of cast and cure, a base film in a roll is coated and the micro or nanostructures are cured through the clear film and the UV resin so that a perfect copy of the 3D image is replicated. Then, a film such as PET, fluoropolymer or any film can be processed through a cast and cure method replicating the structures or negative of the microstructure surface 130 onto the substrate 140. Speeds in this roll-to-roll operation generally are 20 to 150 meters per minute and can be done over two meters wide.

Per the above explanation, the microstructures are then metallized generally with aluminum at the desired optical density at generally less than 100 nm in thickness but up to 300 nm. Generally, this is done via vacuum metallization or deposition or sputtering at high speeds in a roll-to-roll operation. Some vacuum metallization lines can run over 2000 meters per minute.

After metallization, the structures of the microstructure surface 130 generally are covered but not “filled” as the aluminum or other metal conforms to the shape of the structure providing a metal covering or top layer but leaving cavities in either rows or shapes as discussed above with reference to FIGS. 2-4. For example, FIG. 5 illustrates the microstructure surface 130 of FIG. 2 after metallization has been performed to provide a top or covering metallic layer 210 that covers the grooves or microstructures such as groove 180 as well as the surfaces between these microstructures (or groove tips). The thickness of the metal covering or top layer 210 may vary with less than about 0.1 microns shown in FIG. 5.

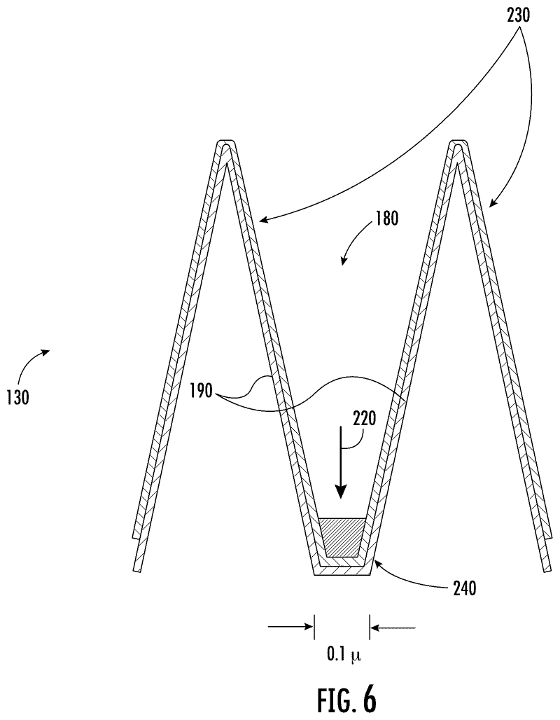

The next challenge is to fill the very narrow shapes with a resist material (e.g., chemical resist) that can be UV, solvent, or water based. FIG. 6 illustrates the microstructure surface 130 of FIG. 5 after application of a resist coating 220 in the bottom of the groove or microstructure 180 and after removal of the metal upper or coating layer except where covered by the resist coating as shown in FIG. 6 as sidewall portions 230 to include the entire sidewalls 190 except for the very lower portion (which may be V-shaped or more U-shaped as shown in FIG. 6 with a lower width of about 0.1 microns, in this example). Note that this is generally the “negative” of the other images in previous diagrams The cavities are filled only at the base of the structures or grooves 180 (or 190 in FIG. 3) with the resist material 220 applied in some cases in a roll-to-roll process that leaves the resist material in the cavities and does not leave residue on the rest of the aluminum or metal layer (layer or coating 210 shown in FIG. 5).

In the next process per the above, the microstructure surface 130 is processed through a combination of sodium hydroxide and water or other cleaning solvents that will remove the aluminum or metal layer from sidewall portions 230 and not the resist coating 220, protecting the aluminum or metal layer 240 underneath the resist 220 and forming an “encapsulated” aluminum or metal layer 240 as shown in FIG. 6.

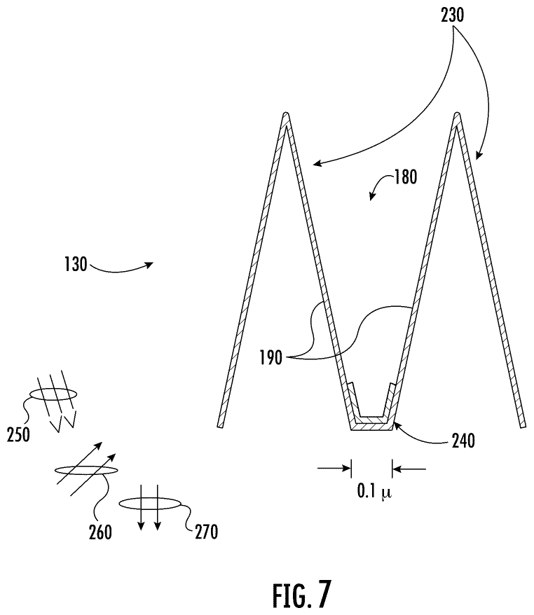

Significantly, the resulting microstructure surface 130 has a nanostructured aluminum or other metal layer or “mask” 240. Particularly, FIG. 7 illustrates the microstructure surface 130 of FIG. 6 after removal of the resist coating 220 and during use to receive sunlight 250, reflect higher wavelength (or heat generating) light 260 such as that of the IR wavelength or greater wavelengths, and to transmit light transmitted light 270 below higher wavelength (e.g., visible light with a wavelength below that of IR light). By reflecting the IR wavelengths or heat with the addition of the IR reflective film system 100, room interior stays cool in the summer and warmer in the winter by reflecting the IR back into the room. Generally, about ten to twenty percent or less of the top surface of the reflector 100 is covered by the reflective mask that reflects wavelengths of visible light (400 to 700 nm). Further, a metal may be chosen for the reflective mask to achieve less loss of visible light that can be absorbed be transmitted through the film into the room. For example, the optical density of aluminum or selected metals may make it useful for the reflective mask as it reflects all or nearly all longer wavelengths (e.g., those longer than about 950 nm) yet allows over half or more of the visible light through the metal reflective mask resulting in less than 10 percent loss of visible light into the room due to the addition of the IR reflective film system 100 of FIG. 7.

One unique idea of the inventors is that a reflective mask is created in the process discussed above with the formation of the IR film system (or “IR reflector element”) 100. The “reflective mask” is provided by a combination of all the remaining pieces or portions (or remains) of the metal layer 240 on the microstructure surface 130 (sunlight-facing surface when installed or in use) of the IR film system (or substrate of silicon or other light transmissive (e.g., nearly transparent) material) 100. The reflective mask blocks or reflects very little visible light and, therefore, allows the visible light into the window (or other transparent sheet of material) with only small loss while not allowing wave lengths longer than a predefined maximum transmitted light wavelength, which may be about 950 nm in some preferred embodiments, into the absorber or panel that would be provided underneath the IR film system 100.

The metallic layer 150 can be magnetron sputtered or vapor deposition deposited onto microstructure surface 130, enabling precise control of metal thickness, and facilitating use of a wide range of metal targets. The metal layer 240 (or metallic layer 150) that make up the “reflective mask” makes up about 10-20% of the surface area of the IR film system 100 that reflect over 50% of the IR yet allow over 50% of the visible light. Therefore, visible light transmission of greater than about 70% and up to about 90% is possible with reflected IR of more than 50% with a metallic surface that takes up about 10-20 % of the surface area.

The substrate140 may be glass or plastic, rigid or flexible, and may comprise any of the transparent supporting materials conventionally used for solar control film, particularly flexible polymer films supplied in web form and having a thickness from about 1 to about 2 mils up to about 50 mils. The thicker films, in addition to supporting the solar control elements, impart safety features to the window system, particularly, shatter resistance, burglary deterrence, blast and ballistic resistance, and wind damage resistance. Suitable polymers for the substrate include polyethylene terephthalate (PET), polyethylene naphthalene (PEN), polycarbonate (PC), polyurethane (PUR), polybutylene (PBN), poly vinyl fluoride (PVF), polyvinylidene fluoride (PVDF) and acrylic. It is preferred that the substrate film be “weatherable”, i.e., comprise a film containing ultraviolet absorbers for wavelengths under about 400 nm

The metallic layer 150 (or metal layer 240) may comprise any of several reflective metals such as aluminum, silver, gold, copper, chromium, and nickel chromium alloys, and may also comprise a metal/metal or metal/metal oxide composite, for example, titanium/silver/titanium or stainless steel/copper/stainless steel. The thickness of the metal film will depend upon the metal or metals selected and the desired levels of VLT and NIRR. Monolayer films would in general have a thickness within the range of from about 20 to about 500 angstroms. Composite film multilayers would in general have a thickness within the range of from about 5 to about 300 angstroms each. In accordance with the invention, the visible light transmission of the metal layer is about 50-90%, preferably more than 60%, and more preferably 65 to 90%.

The hardcoat 170 can be any material such that it meets ASTM Standard D1004 and has less than a 5% delta haze.

The adhesive layer 120 can be a pressure sensitive adhesive. For original equipment manufacturers in the window/glazing industry (OEMs), the film of the invention may be dry laminated to the glass or other glazing material. In exemplary embodiments, the adhesive contains ultraviolet absorbers meeting the specifications established by the Association of Industrial Metallizers, Coaters and Laminators (AIMCAL). In the OEM manufacture of dual pane glazing systems, the solar control film of the invention is preferably affixed to the inner surface of the outer pane. For single pane and retrofit applications, the film is preferably affixed to the inner surface or room side of the window.

The water vapor transmission rate (WVTR) of a solar control film is a very important factor in the aftermarket or retrofit segment of the industry. In the retrofit market, the film is applied to the window glass by a pressure sensitive adhesive system and an installation procedure which requires the use of water. For the adhesive to dry and permanently affix the film to glass, the water must diffuse through the adhesive and the film to the exposed surface of the film to allow for evaporation of the water. Thus, it is important for the film to have a high WVTR to dry quickly. The IR film system 100 described herein has a WVTR of at least 0.4 grams per square meter over 24 hours at one atmosphere, which compares favorably with more conventional solar control films, such that the adhesive will dry in about 3 to 10 days.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. An infrared (IR) reflecting film system, the film system comprising:
a substrate having a first surface capable of being adhered to a transparent sheet of material;
a microstructure surface of the substrate opposite the first surface of the substrate;
a plurality of microstructures cooperating to form the microstructure surface of the substrate, each microstructure with a recessed surface;
a metallic layer disposed on the microstructure surface to reflect IR; and
a plurality demetaliztion areas disposed in the metallic layer sized to permit the transmission of visible light and limit the transmission of light wavelengths that correspond to IR.

2. The film system of claim 1 wherein the demetalization areas limit at least 50 percent of IR and the metallic layer reflects about 40 percent of the IR to about 90 percent.

3. The film system of claim 1 wherein each of the demetalization areas has a diameter of between about 300 nm and about 1 micron.

4. The film system of claim 1 wherein shape of the recessed surfaces forming the plurality of microstructures are linear, round, hexagonal or square.

5. The film system of claim 1 wherein the metal layer metal or metamaterial and has a thickness of less than about 0.1 micron.

6. The film system of claim 1 wherein about 50 percent to about 90 percent of the visible light is permitted to pass through the plurality of demetalization areas.

7. The film system of claim 5 wherein the metal is aluminum or a combination of up to 10 different metallic materials.

8. The film system of claim 1 further comprising a hardcoat disposed over the microstructure surface and the metallic layer.

9. The film system of claim 1 wherein the film system provides a shading coefficient in the order of about 0.52 at a visible light transmission of at least 60 percent.

10. The film system of claim 1 wherein the film system has a water vapor transmission rate of at least 0.4 grams per square meter over 24 hours at one atmosphere.

11. A method of fabricating an IR window film system, the method comprising:
forming a plurality of microstructures on a substrate to create a microstructure surface on the substrate, each of the microstructures having a recessed surface; and
depositing a metallic layer on the microstructure surface of the substrate that reflects a light wavelength greater than about 950 nanometers (nm).

12. The method of claim 11 further comprising depositing a resist layer over the metallic layer at locations to prevent the metallic layer in these areas from being removed to create a plurality of demoralization areas, the plurality demetaliztion areas are sized to permit the transmission of visible light and limit the transmission of light wavelengths that correspond to IR.

13. The method of claim 12 wherein the demetalization areas limit at least 50 percent of IR and the metallic layer reflects about 40 percent of the IR to about 90 percent.

14. The method of claim 12 wherein each of the demetalization areas has a diameter of between about 300 nm and about 1 micron.

15. The method of claim 12 wherein shape of the recessed surfaces forming the plurality of microstructures are linear, round, hexagonal or square.

16. The method of claim 12 wherein the metal layer metal or metamaterial and has a thickness of less than about 0.1 micron.

17. The method of claim 12 wherein about 50 percent to about 90 percent of the visible light is permitted to pass through the plurality of demetalization areas.

18. The method of claim 16 wherein the metal is aluminum or a combination of up to 10 different metallic materials.

19. The method of claim 12 wherein the film system provides a shading coefficient in the order of about 0.52 at a visible light transmission of at least 60 percent.

20. The method of claim 12 wherein the film system has a water vapor transmission rate of at least 0.4 grams per square meter over 24 hours at one atmosphere.
